(19) United States
(12) Patent Application Publication
(10) Pub. No.: US 2008/0172896 A1
(43) Pub. Date: Jul. 24, 2008

(54) Sanding Block

(76) Inventor: Mark Frantellizzi, Kings Park, NY (US)

Correspondence Address: LILLIE LAW, LLC, 269 SOUTHPORT ST, RONKONKOMA, NY, 11779, US

(21) Appl. No.: 11/622,568

(22) Filed: Jan. 12, 2007

(51) Int. Cl. G01B 3/04; B24D 15/02; G01C 9/24

(52) U.S. Cl. 33/485; 451/523; 33/379

(57) ABSTRACT

An improved sanding device comprising a longitudinal body having a shape with a height, length, and width with an outer surface, the body made from a material that is substantially rigid; wherein at least a portion of the surface is topographical for sanding; the device further comprising a leveling feature incorporated within the body for leveling in a first direction.

### BACKGROUND OF THE INVENTION

This invention relates to a sanding device, in particular, a multiple purpose sanding device that includes, inter alia, a level device, and/or a measuring device.

Historically, sanding devices have been used to refine surfaces of various materials, inter alia, such a metal, plastic, and wood, to a desired texture. Most typically, sanding is employed to transform a work in process to a desired texture for a finished product using various grit levels of sandpaper, and ultimately, emory cloth. Moreover, when hanging sheetrock, kitchen cabinets, etc, a user often needs to sand a corner, edge, or the like when installing such materials and products, and also has a need to ensure the finished product is level. As such, the user often needs to carry a plethora of tools, sometimes, fumbling through a spackle pail of tools, or a tool belt for the various tools while holding the materials. As such, there is a need for a tool that meets and exceeds these requirements.

### SUMMARY OF THE INVENTION

The present invention is directed to a sanding device having the primary advantage of improving efficiency of installation through added convenience of a multipurpose tool. In order to accomplish the foregoing advantage, it is preferred that the such device, namely, an improved sanding device include a longitudinal body having a shape with a height, length, and width with an outer surface, said body made from a material that is substantially rigid; wherein at least a portion of said surface is topographical for sanding; said device further comprising a leveling feature incorporated within said body for leveling in a first direction.

In an alternative embodiment, it is also preferred that the improved sanding device include a longitudinal body having a shape with a height, length, and width, a proximal and distal end, said body having an outer surface having at least one side that is substantially flat; wherein at least a portion of said surface is topographical for sanding; said device further comprising a plurality of leveling features incorporated within said body for leveling.

Other objectives, advantages, and novel features of the present invention will become more apparent from the following detailed description when taken in conjunction with the accompanying drawings.

### BRIEF DESCRIPTION OF THE DRAWINGS

The following drawings, in which like reference characters indicate like parts, are provided for illustration of the invention and are not intended to limit the invention in any manner whatsoever.

FIG. 1 illustrates a front view of the preferred embodiment;

FIG. 2 illustrates a side view of the preferred embodiment;

FIG. 3 illustrates a rear view of the preferred embodiment;

FIG. 4 illustrates a front view of an alternative embodiment;

FIG. 5 illustrates a side view of an alternative embodiment; and

FIG. 6 illustrates a rear view of an alternative embodiment.

### DETAILED DESCRIPTION OF THE INVENTION

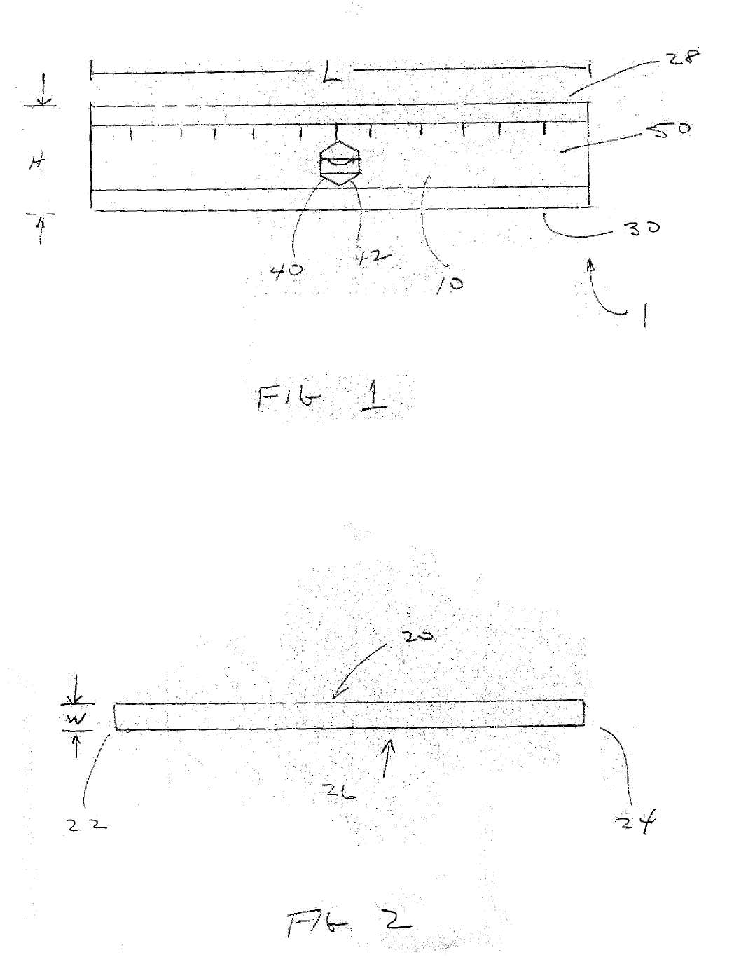

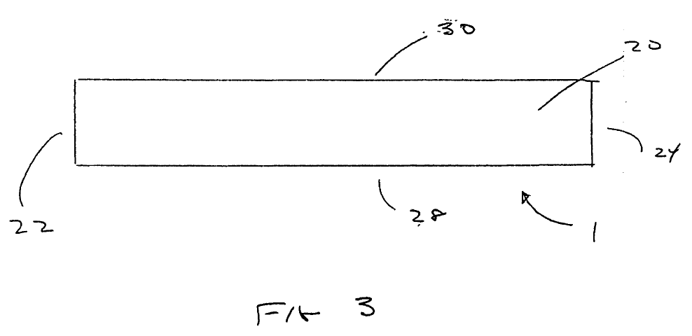

The following descriptions of the preferred embodiments are presented to illustrate the present invention and are not to be construed to limit the claims in any manner whatsoever. In reference to the drawings, namely FIGS. 1 to 3, the preferred embodiment of the present invention is disclosed, which is directed to an improved sanding device 1 comprising: a longitudinal body 10 having a shape with a height H, length L, and width W with an outer surface, preferably, where the shape is a square or rectangular block, although it is envisioned that other three-dimensional shapes may be incorporated, e.g., a triangle block may be employed for tough to get to corners. The body 10 is preferably made from a material that is substantially rigid, wherein at least a portion of said surface is topographical for sanding, rasping, moulding or contouring a piece of a material, such as a cabinet, piece of sheetrock, a piece of wood, or a piece of metal or plastic etc., whether the material needs to be sanded externally, or internally, such as a cutout therein. The body 10 is made from a material having the characteristics of substantially solid, and lightweight, such as a metal, a plastic, or a wood or combination thereof, although it is preferred that that the material be rigid, it is envisioned that a malleable material maybe incorporated, e.g., sheet metal, or Plexiglas® or the like, as this enables the user to sand variable meniscuses, e.g., a variable concave or convex surface, and may even include a sponge like material, such as currently used by Minnesota Mining and Manufacturing (aka 3M) Norton, and Craftsman®.

It is preferred that said shape has at least one side 20 that is flat, as this would be the sanding side, and that said outer surface further include a piece of sandpaper affixed thereto via an adhesive or other commonly known method. However, it is envisioned that the other sides 22, 24, 26, 28, 30 may be of various shapes and sizes (not shown), for example, curved on various angles, and that such non flat sides 22, 24, 26, 28, 30 may be used as sanding sides as well. Furthermore, the outer surface, if made from metal or other hard material, may alone be used for sanding, providing the material of the outer surface is harder than the material to be sanded. In all scenarios, any given sanding side would be substantially uniform in nature.

Moreover, it is envisioned that said device 1 further include a leveling feature 40 incorporated within said body 10 for leveling in a first direction, e.g., the x-axis. The leveling feature 40 is incorporated into the center C of said body 10, such as a spirit or bubble level, although it is only necessary to have said leveling feature 40 as recessed from said outer surface when the sanding side 26 is the same as the viewing side of the leveling feature, this prevents the glass or plastic container holding the fluid (aka spirit) from getting scratched which would, in the short term, hinder viewability thereof, or in the long term, prevent or inhibit the viewing of the leveling spirit entirely.

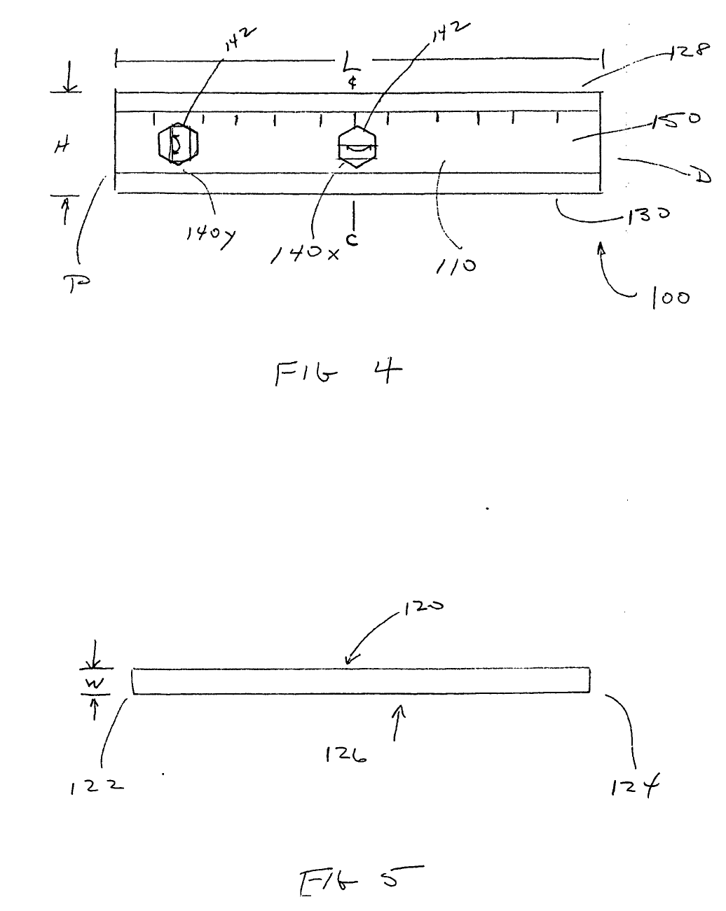

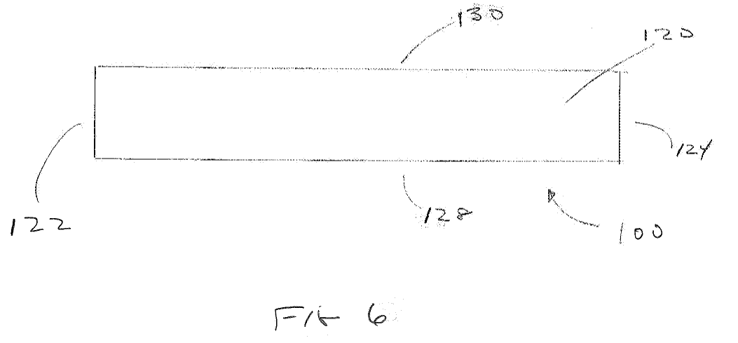

In the preferred embodiment, the spirit is viewable only from one side 26. For example, the leveling feature 40 may be adjusted to one or more predetermined angles, e.g., 15, 30, 45, 60, 75 degree angles, or as illustrated in FIG. 4, 0, 45, 90 degree angles, by rotating the liquid container within the feature housing 42. In this embodiment, the liquid container has a hexagon ring about its ends, which mate with and fits within another hexagon ring housing 42. The angle adjustment may be made by removing threaded fasters and then removing the liquid container and the ring thereabout from the housing 42, rotating to desired angle, and reinserting to the desired angle, and inserting and refastening the fasteners. Although it is envisioned that even more angles may be used, but it is recommended that a polygon shape be used for the ring and housing so as to minimize the stress on the threaded fasteners.

Additional features that may be included with the device 1 include a measuring device 50, e.g., a laser beam or, preferably, a ruler, although it is preferred that a ruler be incorporated into said outer surface that runs substantially the entire length L of said sanding device 1. It is preferred that the measuring device 50 be mounted recessed so as to not interfere with any sanding surfaces and to maximize the life expectancy of the markings on the ruler. The measuring device 50 may be a device fabricated afterwards and incorporated with the body 10 via an adhesive or other commonly known method, such as a ruler or, the measuring device 50 may be incorporated directly into the body 10, such as etching markings on the body 10.

In alternative embodiments (not shown), an improved sanding device 100 comprises a longitudinal body 110 having a shape with a height H, length L, and width W, a proximal and distal end P, D, said body 110 having an outer surface having at least one side 120 that is substantially flat; wherein at least a portion of said surface is topographical for sanding; said device 100 further comprising a plurality of leveling features 140 incorporated within said body 110 for leveling. Wherein said body 110 is made from a material that has the following characteristics: is substantially solid, and lightweight, and wherein said material is made from a metal, a plastic, or a wood.

A first leveling feature 140x is incorporated into the center C of said body 110, and a second leveling feature 140y is incorporated near one of said ends P or D, illustrated in FIG. 4 near the proximal end P, wherein said leveling features 140 are spirit levels, and preferably recessed from said outer surface. The outer surface further includes a piece of sandpaper, and wherein at least one of said leveling features 140 is adjustable. For example, one or more features 140 may be adjusted to one or more predetermined angles, e.g., 15, 30, 45, 60, 75 degree angles, or as illustrated in FIG. 4, 0, 45, 90 degree angles, by rotating the liquid container within the feature housing 142. In this embodiment, the liquid container has a hexagon ring about its ends, which mate with and fits within another hexagon ring housing 142. The angle adjustment may be made by removing the threaded fasters, removing the liquid container and the ring thereabout from the housing 142, rotating to desired angle, and reinserting to the desired angle, and inserting and refastening the fasteners. It is envisioned that even more angles may be used, but it is recommended that a polygon shape be used for the ring and housing so as to minimize the stress on the threaded fasteners.

In this embodiment, the device 100 further includes a measuring device 150, wherein said measuring device 150 is a ruler, attached to said outer surface that runs substantially the entire length of said sanding device 100. The measuring device 150 may be various scaling, such as British, Metric, Architect's, Engineer's system, wherein the upper limit of length of the rule would be limited to the length L of body 110.

All of the above referenced patents; patent applications and publications are hereby incorporated by reference. Many variations of the present invention will suggest themselves to those of ordinary skill in the art in light of the above detailed description. All such obvious modifications are within the full-intended spirit and scope of the claims of the present application.

1. An improved sanding device comprising:
a longitudinal body having a shape with a height, length, and width with an outer surface, said body made from a material that is substantially rigid; wherein at least a portion of said surface is topographical for sanding; said device further comprising a leveling feature incorporated within said body for leveling in a first direction, such that the perimeter of said feature is below said surface.

2. A device as in claim 1, wherein said body is made from a material that is substantially solid, and lightweight.

3. A device as in claim 1, wherein said material is made from a metal, a plastic, a sponge-like material, or a wood.

4. A device as in claim 1, wherein said shape has at least one side that is flat.

5. A device as in claim 1, wherein said leveling feature is incorporated into the center of said body.

6. (canceled)

7. (canceled)

8. A device as in claim 1, wherein said outer surface further includes a piece of sandpaper.

9. A device as in claim 1, wherein said device further includes a second leveling feature for leveling in a second direction.

10. A device as in claim 1, further comprising a ruler incorporated into said outer surface that runs substantially the length of said sanding device, wherein said ruler is recessed from said surface.

11. An improved sanding device comprising:
a longitudinal body having a shape with a height, length, and width, a proximal and distal end, said body having an outer surface having at least one side that is substantially flat;
wherein at least a portion of said surface is topographical for sanding; said device further comprising a plurality of leveling features incorporated within said body for leveling, such that the perimeter of said feature is below said surface.

12. A device as in claim 11, wherein said body is made from a material that is substantially solid, and lightweight.

13. A device as in claim 11, wherein said material is made from a metal, a plastic, a sponge-like material, or a wood.

14. A device as in claim 11, wherein a first leveling feature is incorporated into I the center of said body, and a second leveling feature is incorporated near one of said ends.

15. (canceled)

16. (canceled)

17. A device as in claim 11, wherein said outer surface further includes a piece of sandpaper.

18. A device as in claim 11, wherein at least one of said leveling features is adjustable.

19. A device as in claim 11, further comprising a measuring device which is recessed below said surface.

20. A device as in claim 19, wherein said measuring device is a ruler, attached to said outer surface that runs substantially the length of said sanding device.

21. A device as in claim 1, wherein said outer surface further includes a sponge-like material.

22. (canceled)
